(19) United States
(12) Patent Application Publication
(10) Pub. No.: US 2017/0068741 A1
(43) Pub. Date: Mar. 9, 2017

(54) SYSTEM AND METHOD FOR AGGREGATING AND CURATING MEDIA CONTENT

(71) Applicant: Fred Silverman, Bedford Hills, NY (US)

(72) Inventor: Fred Silverman, Bedford Hills, NY (US)

(21) Appl. No.: 15/356,777

(22) Filed: Nov. 21, 2016

Related U.S. Application Data
(63) Continuation of application No. 12/930,007, filed on Dec. 23, 2010, now abandoned.
(60) Provisional application No. 61/289,493, filed on Dec. 23, 2009.

(51) Int. Cl. G06F 17/30

(52) U.S. Cl. CPC G06F 17/30867; G06F 17/30781

(57) ABSTRACT

A method and system for aggregating and curating a plurality of media content pieces. The method including the steps of aggregating a plurality of media content pieces from various sources and curating each of the plurality of media content pieces to determine metadata associated with each of the plurality of media content pieces including an ideology level for each of the media content pieces. Each of the media content pieces and determined metadata are stored in a database. The stored/aggregated media content pieces are then made accessible to a user using a search feature that selects at least one of the plurality of media content pieces based upon metadata stored in the database.

### FIELD OF THE INVENTION

The invention relates to a system and method for aggregating media content, and more specifically, for certain aggregated media content.

### BACKGROUND OF THE INVENTION

Today's broadcast corporations, advertising agencies, consumer products and services companies, and other businesses have demanding media asset management needs. These organizations have been simultaneously empowered by the growth in tools and infrastructure for creating, storing and transporting media-rich files and challenged by the problem of managing the media assets that they've amassed and come to rely upon for their core businesses. The sheer volume of information available over the World Wide Web and corporate networks continues to accelerate. Because media assets are so crucial to these companies, they have an extreme need for an intelligent and efficient way to catalog, browse, search and manage their media assets. Prior attempts at a content management solution have yielded point solutions or proprietary applications. These applications have not leveraged the technologies already deployed by many organizations, such as industry-standard browsers and Web servers.

As the World Wide Web has emerged as a major research tool across all fields of study, the concept of metadata has become a crucial topic. Metadata, which can be broadly defined as “data about data,” refers to the searchable definitions used to locate information. This issue is particularly relevant to searches on the Web, where metatags may determine the ease with which a particular Web site is located by searchers. Metadata that are embedded with content is called embedded metadata. A data repository typically stores the metadata detached from the data.

Results obtained from search engine queries are limited to metadata information stored in a data repository, referred to as an index. With respect to media files or streams, the metadata information that describes the audio content or the video content is typically limited to information provided by the content publisher. For example, the metadata information associated with audio/video podcasts generally consists of a URL link to the podcast, title, and a brief summary of its content. If this limited information fails to satisfy a search query, the search engine is not likely to provide the corresponding audio/video podcast as a search result even if the actual content of the audio/video podcast satisfies the query.

### SUMMARY OF THE INVENTION

In one aspect, a system and method is described in which an aspect of the invention includes aggregating and curating a plurality of media content pieces from various sources to determine metadata associated with each of the plurality of media content pieces. The metadata preferably includes a determined ideology level for each of the media content pieces. Each of the media content pieces and determined metadata are stored in a database. The stored/aggregated media content pieces are then made accessible to a user using a search feature that selects at least one of the plurality of media content pieces based upon metadata stored in the database.

In further, optional aspects, the foregoing method can include the additional step of selectively relating each of the plurality of media content pieces based upon the stored metadata relating to each of the plurality of media content pieces. In another aspect of the invention, a filter is provided for enabling a user to select an ideology level of media content pieces desired to be retrieved by the user.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a block diagram of a computer system to be used with illustrated embodiments of the invention;

FIG. 2 is a system level diagram depicting an environment of use for the invention is accordance with an illustrated embodiment;

FIG. 3 is a flow chart depicting certain steps for curating media content pieces in accordance with an illustrated embodiment of the invention; and

FIGS. 4-6 depict a website for presenting curated media content pieces to a user in accordance with an illustrated embodiment of the invention.

### WRITTEN DESCRIPTION OF CERTAIN EMBODIMENTS OF THE INVENTION

The present invention is now described more fully with reference to the accompanying drawings, in which an illustrated embodiment of the invention is shown. The invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

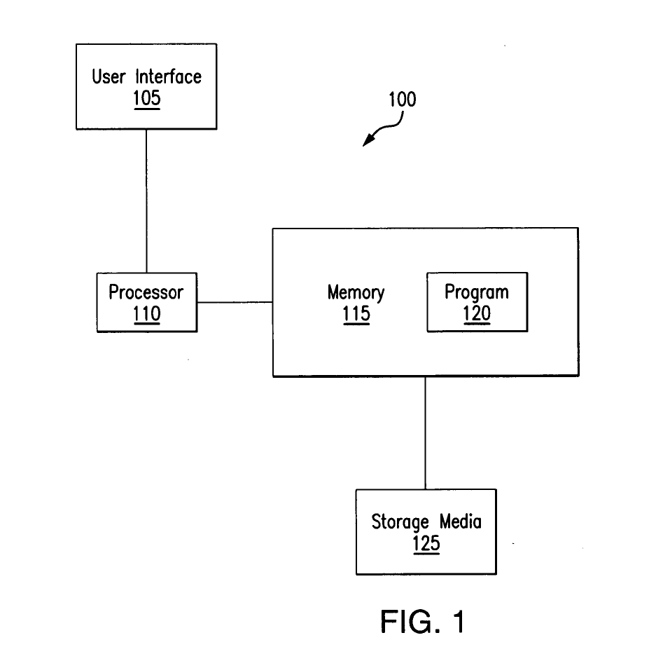

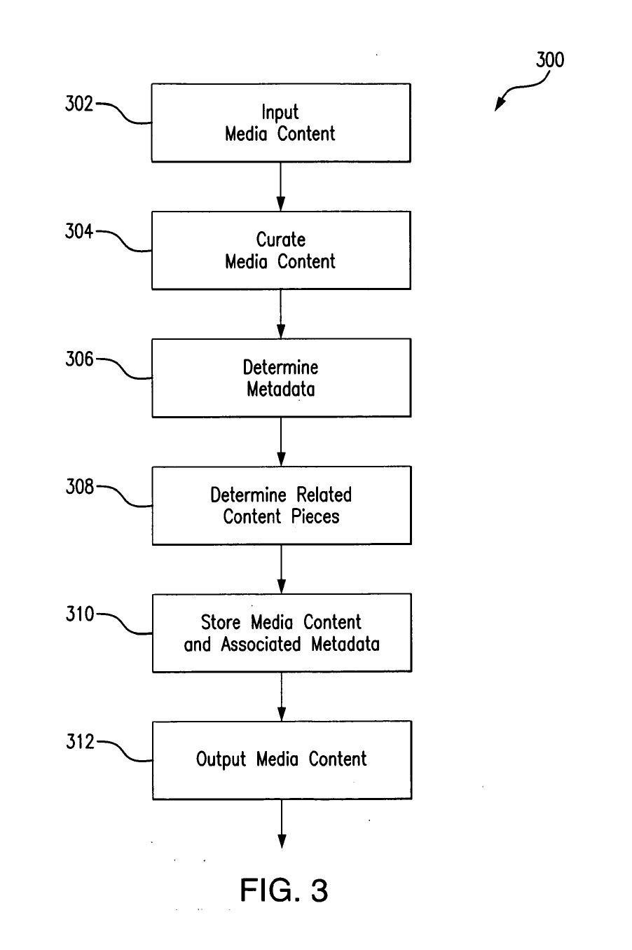

It is to be appreciated that the embodiments of this invention as discussed below may be incorporated as a software algorithm, program or code residing on computer useable medium having control logic for enabling execution on a computer system having a computer processor. The computer system typically includes memory storage configured to provide output from execution of the computer algorithm or program. Such a computer system is shown as a block diagram in FIG. 1 illustrating a computer system 100 configured for employment of method 300 (FIG. 3) in accordance with an illustrated embodiment of the invention. System 100 preferably includes a user interface 105, a processor 110, and a memory 115. System 100 may be implemented on a general purpose microcomputer, such as one of the members of the Sun® Microsystems family of computer systems, one of the members of the IBM® Personal Computer family, one of the members of the Apple® Computer family, or a myriad of other conventional workstations, desktop computer, laptop computer, a netbook computer, a personal digital assistant, or a smart phone or other like handheld devices. Although system 100 is represented herein as a standalone system, it is not limited to such, but instead can be coupled to other computer systems via a network (not shown).

Memory 115 is a memory for storing data and instructions suitable for controlling the operation of processor 110. An implementation of memory 115 would include a random access memory (RAM), a hard drive and a read only memory (ROM). One of the components stored in memory 115 is a program 120.

Program 120 includes instructions for controlling processor 110 to execute method 100. Program 120 may be implemented as a single module or as a plurality of modules that operate in cooperation with one another. Program 120 is contemplated as representing a software embodiment of the method described hereinabove.

User interface 105 preferably includes an input device, such as a keyboard, touch screen, tablet, or speech recognition subsystem, for enabling a user to communicate information and command selections to processor 110. User interface 105 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 110.

While program 120 is indicated as already loaded into memory 115, it may be configured on a storage media 125 for subsequent loading into memory 115. Storage media 125 can be any conventional storage media such as a magnetic tape, an optical storage media, a compact disc, or a floppy disc. Alternatively, storage media 125 can be a random access memory, or other type of electronic storage, located on a remote storage system.

The methods described herein have been indicated in connection with flow diagrams that facilitate a description of the principal processes; however, certain blocks can be invoked in an arbitrary order, such as when the events drive the program flow such as in an object-oriented program. Accordingly, the flow diagram is to be understood as an example flow and that the blocks can be invoked in a different order than as illustrated.

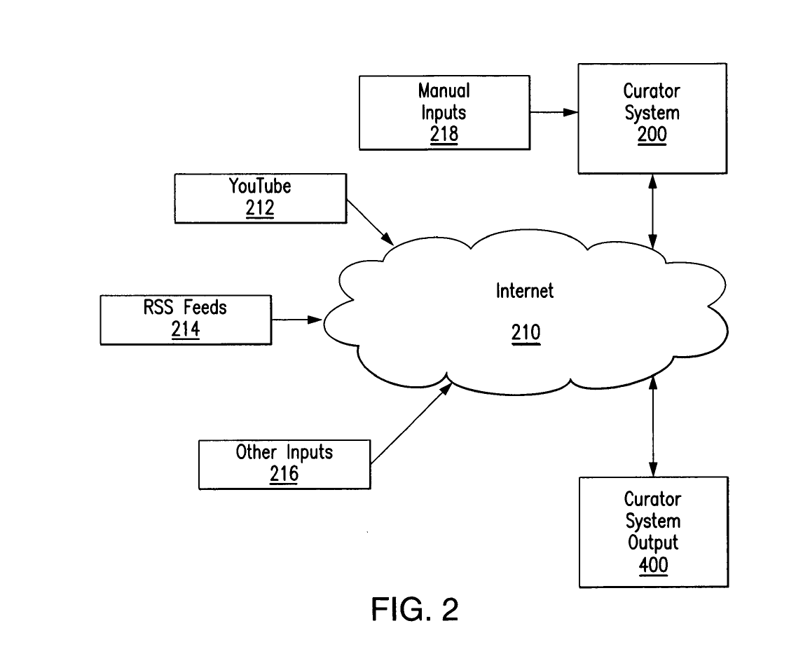

With reference now to FIG. 2, depicted is an illustrated environment of use for curator system 200 (preferably embodying components of the aforesaid computer system 100 of FIG.1) in accordance with an illustrated embodiment of the present invention. As to be discussed further below, curator system 200 provides curator services preferably for inputted news and media content (“content pieces”), such as providing detailed metadata information for each input content piece to be used by a recipient for selectively choosing which content piece the recipient desires to access. It is to be appreciated that while curator system 200 is to be described in conjunction with video clip segments and news articles, it is not to be understood to be limited thereto as it may encompass various forms of content (advertisements, product reviews, literature, dramatic works, etc.) and/or data where such curator services provide a value to a recipient for selecting such content to access.

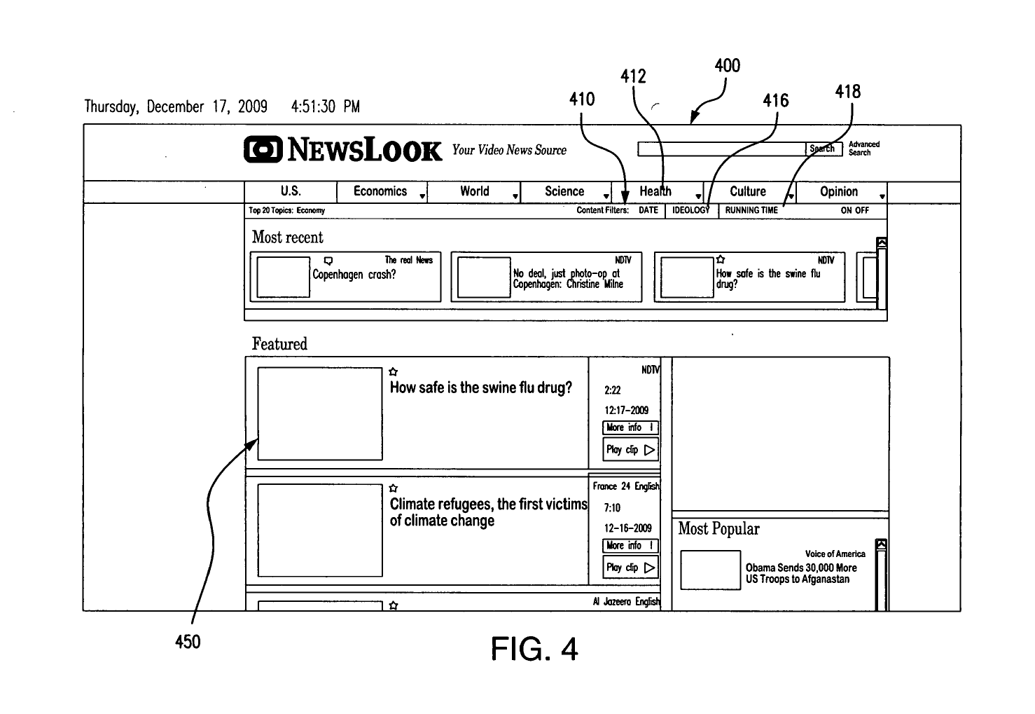

As shown in FIG. 2, content may be provided to the curator system 200 from various sources and distribution channels including YOUTUBE™ 212, RSS Feeds 214 and other like sources 216 providing desired content preferably accessible via the internet 210. Content may also be inputted directly to curator system 200 through conventional means such as pasteing and cutting. As described further below, the output of curator system 200 in accordance with the illustrated embodiment is provided via a website that preferably aggregates and selectively relates a plurality of content pieces. However, the output of curator system 200 is not to be understood to be limited to such a website service offering as depicted in FIG. 4 but may be provided in various output formats and/or to various device types including mobile devices (such as cell phones, smart phones, PDA's and the like), cable and satellite television systems and formats, and other internet based services and formats.

With an environment of use described above for curator system 200, its method of operation in accordance with an illustrated embodiment will now be discussed with reference to FIG. 3. Starting at step 302, a content piece (such as a media clip) is input to curator system 200. A curation process is then performed on the aforesaid content piece to determine certain metadata associated with the content piece, step 304. It is to be appreciated this curation process may be performed on the content piece either via a software program, a manual process or a combination of both. Thus, the curation process involves determining metadata relating to certain categories of information from analysis of the content piece, step 306.

The determined curated information (metadata) (step 306) obtained from an actual review/analysis of the content piece relates to a number of categories, including (but not limited to):
Topical category (and subcategories) of the content piece (e.g., U.S., Economics (Business, Markets, Policy, Personal Finance), World (Africa, Americas, Asia/Pacific, Europe, Middle East), Science (Research, Technology, Environment), Health (Research, Aliments & Cures, Policy), Culture (Arts & Culture, Comedy) and Opinion (video blogs))
Content Piece description and/or summary
Length/Duration of the content piece (e.g., number of words, length of video/media segment)
Date of origin of the content piece
Ideology level of the content piece (preferably categorized according to a scale or spectrum ranging from very progressive to very conservative)
Supplier of content piece
Geographic location of content piece supplier

Next, at step 308, a determination is made as to what other content pieces stored in curator system 200 (which have each preferably underwent the aforesaid curation process of FIG. 3) relate to the content piece that is currently the subject of the curation process of FIG. 3. This determination is preferably based upon consideration and matching of the curated information (metadata) associated with each aforesaid stored content pieces and the content piece that is currently the subject of the curation process. This determination preferably includes factors such as (but is not limited to):
Supplier of content piece
Supplier Organization type
Supplier geographic location
Content piece description and/or summary
Content piece production date
Ideology level of content piece

After the determination of related content pieces is performed (step 308), the content piece, associated determined curated information (metadata) and preferably links to related content pieces are stored in a database/memory in curator system 200, step 310. From the aforesaid database/memory of curator system 200, the content pieces are provided to users via an output system, step 312.

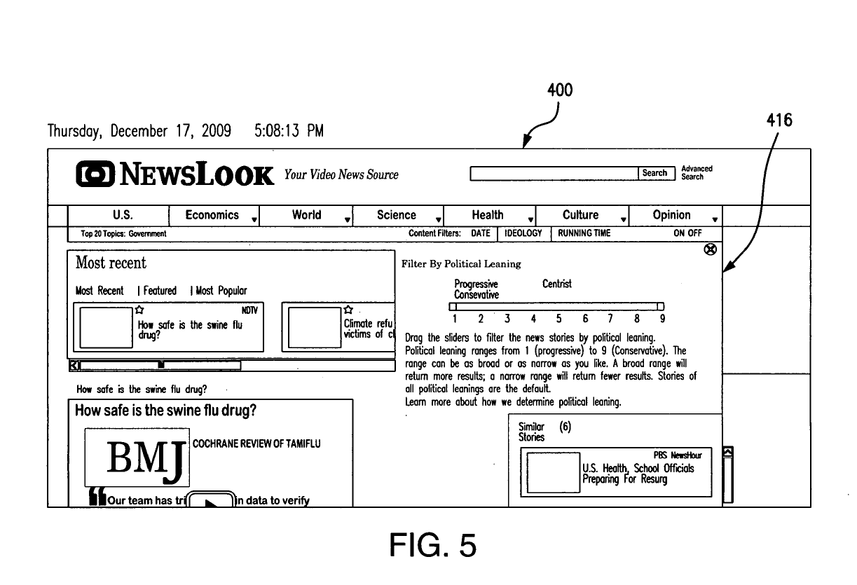

With reference now to FIG. 4, and in accordance with an illustrated embodiment of the invention, shown is a website 400 providing selective access to the content pieces stored in the curator system 200 as described above, a content filter 410 is provided which filters content pieces to be retrieved in accordance with the filter settings chosen by a user. For instance, a user can restrict retrieved content pieces according to the following determined curated information (metadata):
Date (412) of the content piece origin (e.g., today, this week, this month, this year, all dates)
Ideology (416) level of the content piece (FIG. 5) in which preferably a sliding scale is provided enabling the user to drag the slider to filter content pieces by determined ideology level for each stored content piece. As indicated in FIG. 5 the filter provides a political ideology range leaning from first setting (1) (Progressive) to a last setting (9) (Conservative). The range can be as broad or as narrow as selected by a user. Preferably, a broad range will return more results (i.e., content pieces) with a narrow range returning fewer results (i.e., content pieces)
Duration of content piece (e.g., less than 3 minutes, 3-10 minutes, longer than 6 minutes)

Once the content filter settings (410) are selected by a user, all content pieces retrieved by the website portal 400 will be retrieved and filtered in accordance with the user selected filter settings. For example, if a user prescribes the filter settings (410) such that only content pieces originating from this week, are conservative rating determined, and have a duration of less than 3 minutes, then only content pieces matching this criteria will be presented to a user if the user selects the category menu (430) or search feature (440) to retrieve content pieces.

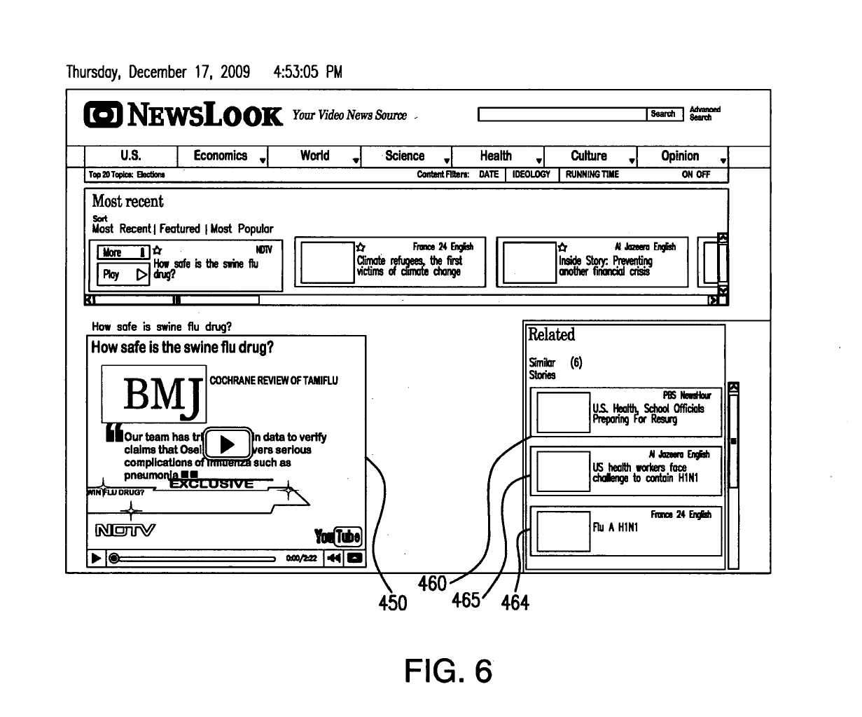

With reference now to FIG. 6, once a content piece (450) is presented for viewing to a user, associated with that content piece (450) are content pieces (460-464) determined to be related to the selected and presented content piece (450) in accordance with the process described above (FIG. 3, step 308).

Therefore, in accordance with the above illustrated embodiments of the invention, what has been described is a system and method that provides customized and individual curation services for each media content piece to be aggregated with one another while providing enhanced informational background material on each content piece for placing each piece in better informational perspective for a user. This system and method enables users to readily select desired media content pieces to access in accordance with each user's predetermined criteria for doing so. Optional embodiments of the invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the scope of the present invention.

What is claimed is:

1. A computer-implemented method for aggregating and curating a plurality of media content pieces, the method comprising the steps of:
aggregating a plurality of media content pieces in a computer processor;
configuring the computer processor to curate each of the aggregated plurality of media content pieces to determine metadata for each of the aggregated plurality of media content pieces; and
making accessible each of the plurality of media pieces stored in the storage device to a user using a search feature that selects at least one of the plurality of media content pieces based upon metadata stored in the storage device.

2. A computer-implemented method for aggregating and curating a plurality of media content pieces as recited in claim 1 further including the step of selectively relating each of the plurality of media content pieces based upon the stored metadata relating to each of the plurality of media content pieces.

3. A computer-implemented method for aggregating and curating a plurality of media content pieces as recited in claim 1 wherein the media content pieces are video segments.

4. A computer-implemented method for aggregating and curating a plurality of media content pieces as recited in claim 1 wherein the media content pieces are selected from the group consisting of video segments and written segments.

5. A computer-implemented method for aggregating and curating a plurality of media content pieces as recited in claim 1 wherein the metadata in the curating step relates to a determined ideology level of a media content piece.

6. A computer-implemented method for aggregating and curating a plurality of media content pieces as recited in claim 1 wherein the making accessible site includes providing a website on the internet.

7. A computer-implemented method for aggregating and curating a plurality of media content pieces as recited in claim 6 wherein the website provides a user selectable filter for selecting an ideology level of media content pieces to be retrieved by a user.

8. A computer program product comprising a computer useable medium having control logic stored therein for causing a computer to aggregate and curate a plurality of media content pieces, said control logic comprising:
first computer readable program means for causing the computer to aggregate a plurality of media content pieces;
second computer readable program means for causing the computer to curate each of the aggregated plurality of media content pieces to determine metadata for each of the aggregated plurality of media content pieces;
third computer readable program means for causing the computer to store each of the aggregated plurality of media content pieces and its determined metadata in association with one another in a computer memory storage device; and
fourth computer readable program means for causing the computer to make accessible each of the plurality of media pieces stored in the storage device to a user using a search feature that selects at least one of the plurality of media content pieces based upon metadata stored in the computer memory storage device.

9. A computer program product as recited in claim 8 wherein the second computer readable program means further causes the computer to selectively relate each of the plurality of media content pieces based upon the stored metadata relating to each of the plurality of media content pieces.

10. A computer program product as recited in claim 8 wherein the media content pieces are video segments.

11. A computer program product as recited in claim 8 wherein the media content pieces are selected from the group consisting of video segments and written segments.

12. A computer program product as recited in claim 8 wherein the metadata relates to a determined ideology level of a media content piece.

13. A computer program product as recited in claim 8 wherein the fourth computer readable program means further causes the computer to provide a website on the Internet for making accessible each of the plurality of media pieces stored in the storage device.

14. A computer program product as recited in claim 8 wherein the website provides a user selectable filter for selecting an ideology level of media content pieces to be retrieved by a user.
